(19) United States
(12) Patent Application Publication
(10) Pub. No.: US 2004/0103194 A1
(43) Pub. Date: May 27, 2004

(54) Method and system for server load balancing

(75) Inventors: Nayeem Islam, Palo Alto, CA (US); Shahid Shoaib, San Jose, CA (US)

Correspondence Address: Michael J. Mallie, Blakely Sokoloff Taylor & Zafman LLP, 12400 Wilshire Boulevard, Seventh Floor, Los Angeles, CA, 90025, US

(73) Assignee: DoCoMo Communicatios Laboratories USA, Inc.

(21) Appl. No.: 10/300,979

(22) Filed: Nov. 21, 2002

(51) Int. Cl. G06F 15/173

(52) U.S. Cl. 709/225

(57) ABSTRACT

In one aspect of the invention, a method for load balancing a plurality of servers is provided. The method comprises intercepting a request from a requestor client forming part of a client group for a service provided by the plurality of servers, determining wait times for servicing prior requests from at least one member client of the client group by at least one of the plurality of servers, and selecting an execution server from among the plurality of servers for responding to the request dynamically based on a computation of the wait times.

### RELATED APPLICATION

This application is related to application Ser. No. 10/179,910, Attorney Docket No. 10745/125, filed Jun. 24, 2002, entitled “Method and System for Application Load Balancing,” naming as inventors Nayeem Islam and Shahid Shoaib.

### FIELD OF THE INVENTION

The present invention relates generally to a system and method for server load balancing. In particular, it relates to load balancing server traffic across a group of servers based on response times of user interface events at clients communicating with the servers.

### BACKGROUND

A networked distributed system is a common computing paradigm for sharing information and resources. A distributed system is a group of computing devices interconnected with a communication network to implement an application. A popular architecture used in distributed systems is a client-server model, in which smaller, less powerful client computing devices request services and information from more intelligent and resource rich server computers.

Today, the large scale proliferation of mobile client computing devices is profoundly changing the way people exchange information in their personal and work environments. An example of a well known client-server system is the World Wide Web (“Web”), which uses the Hypertext Transfer Protocol (“HTTP”) protocol to transmit data over the global network of computers known as the Internet. Web clients use graphical interfaces to access and display Web documents or pages from Web servers. The increasingly widespread use of the Internet and the Web is placing ever tougher demands on network servers. Consequently, service providers have turned to various server load balancing techniques that distribute client requests among different machines in a group of servers known as a server farm in an attempt to control server traffic.

Traditional techniques for load balancing server traffic across multiple servers in a server farm system have used a Domain Naming System (“DNS”) server to implement a round robin algorithm for randomly rotating through a list of servers. Other known techniques for distributing server load employ network switches, such as the Catalyst 6000 series switches manufactured by Cisco Systems of San Jose, Calif. These network switches are placed in front of a server farm to implement, for example, a weighted round robin algorithm that selects among multiple servers in a sever farm in a circular fashion based on each server's capacity to handle connections with clients. These switches can also deploy least-connections algorithms that rely on server load metrics. For example, a simple least-connection algorithm may select the server having the fewest active connections or a weighted least-connection algorithm may select a server whose number of active connections is farthest below its calculated relative capacity to handle connections with clients.

However, research has shown that the response times of user interface events significantly affect user perception of the performance of a system. In other words, users will find the performance of a system to be objectionable if they must wait for too long for the system to respond to a user request. Conventional server load balancing techniques fail to effectively optimize user perceived performance of a system because they fail to account directly for response times and instead distribute server traffic in an arbitrary fashion or based on a measure of server load. Moreover, these techniques require specific or dedicated hardware resources for implementation.

Therefore, there is a need for an improved server load balancing system and method that effectively optimizes user perceived performance of a system using a measure of system response times as a metric for load balancing server traffic. Furthermore, there is a need for a load balancing system that can be deployed using general purpose computing hardware for greater flexibility and reduced cost of implementation.

### SUMMARY

In one aspect of the invention, a method for load balancing a plurality of servers is provided. The method comprises intercepting a request from a requestor client forming part of a client group for a service provided by the plurality of servers, determining wait times for servicing prior requests from at least one member client of the client group by at least one of the plurality of servers, and selecting an execution server from among the plurality of servers for responding to the request dynamically based on a computation of the wait times.

In another aspect of the invention, a system for load balancing a plurality of servers is provided. The system comprises a client group that includes at least one client operable to generate a request for a service provided by the plurality of servers. The system also comprises a record of wait times for servicing prior requests from said client group by at least one of the plurality of servers. The system further comprises a load balancing agent that executes on one of the plurality of servers. The load balancing agent is capable of intercepting the request and selecting an execution server from among the plurality of servers for responding to the request dynamically based on a computation of the wait times.

### BRIEF DESCRIPTION OF THE DRAWINGS

The accompanying drawings, which are incorporated in and constitute a part of this specification, illustrate embodiments of the invention and, together with the description, serve to explain the advantages and principles of the invention. In the drawings,

FIG. 1 is a block diagram showing a timeline for user interface events of a mobile application;

FIG. 2 is a block diagram showing a model client-server system for server load balancing according to an embodiment of the present invention;

FIG. 3 is a graphical illustration of a table for storing wait time metrics for server load balancing in the model client-server system of FIG. 2;

FIG. 4 is a flow chart showing a server load balancing process according to an embodiment of the present invention;

FIG. 5a is a decision tree showing an exemplary algorithm for selecting a server in the server load balancing process of FIG. 4;

FIG. 5b is a decision tree showing another algorithm for selecting a server in the server load balancing process of FIG. 4; and

FIG. 6 is a decision tree showing an exemplary algorithm for diagnosing a system overload in the server load balancing process of FIG. 4.

### DETAILED DESCRIPTION OF THE PREFERRED EMBODIMENTS

Reference will now be made in detail to an implementation of the present invention as illustrated in the accompanying drawings, wherein like components are identified with the same references. The disclosed embodiments of the present invention are described below using a Hypertext Transfer Protocol (“HTTP”) based client-server system. However, it will be readily understood that the HTTP transport protocol is not the only protocol for implementing the present invention, and the present invention may be implemented under other types of client-server systems, such as TCP, SCTP, and UDP based systems.

When a user interacts with a client device to request services or information from a server device interconnected with a network, the response time for fulfilling a user's request significantly affects the user perceived performance of the system. According to an embodiment of the present invention, response times of user interface events are measured and used to load balance server traffic, and in particular to distribute client requests across multiple servers that can provide requested services. As described in greater detail further below, the method and system for server load balancing according to the present invention can use differently configured load balancing algorithms to select the optimal server from among a group of servers to respond to a client request for improving the user experience.

1. Application Model

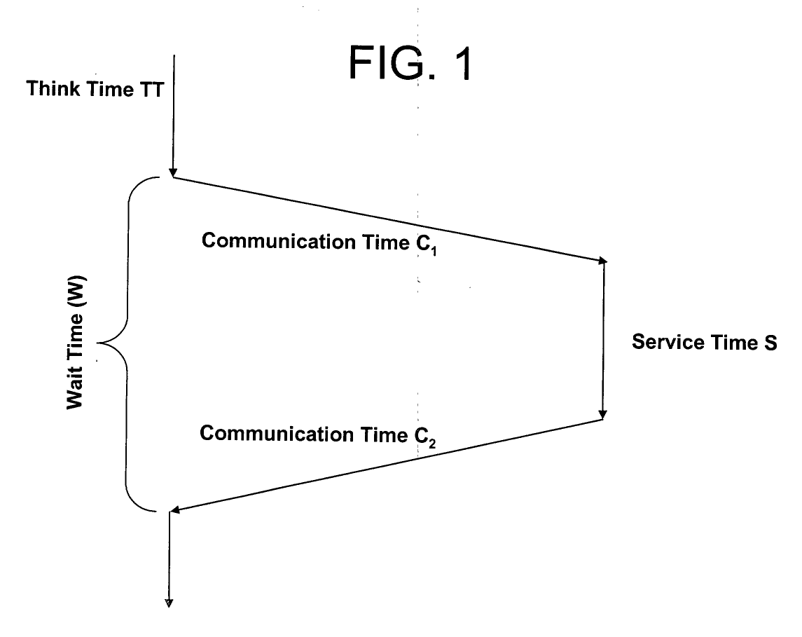

In order to explain the performance optimization made possible using server load balancing techniques according to the present invention, a timeline for user interface events in a client-server system is shown in FIG. 1. Specifically, a user at a client device seeking to access services provided by a server-side application moves through alternate think times TT and wait times W. At the end of each think time, the user issues a request to the server from the client and waits for a reply. The server-side application typically waits in a loop for requests from the user. On receiving a user request, the server may perform computations and access data to fulfill the user's request. It will then send back a reply to the user.

For example, in HTML based applications, users can interact with a web browser on a client device to request information from a server device by posting web page forms or by clicking on Uniform Resource Locator (“URL”) links to get a web page from the sever. These actions of users for requesting services or information, including the act of filling in a form and waiting for a response and the act of clicking on a link and getting a page, are referred to as user interface events.

The wait time W of a user interface event is the time associated with processing a client request. Specifically, when a user at a client device sends a request to a remote server-side application, the wait time W of user interface events can be broken down into 1) the total time spent in communications between the client and server, and 2) the total service time for the server to fulfill the user request, including the time spent in computation and in data input/output operations by the requested server-side application.

Accordingly, the following calculation can be made:

W=C+S (1)

where:

W is the wait time;

C is the total time spent in communications and is the sum of communication times in both directions, C₁ and C₂; and

S is the total service time and it is the sum of time spent in computation plus data I/O time.

If the parameters C and S are continuous random variables, then the following relationships hold for their means:

a(W)=a(C)+a(S) (2)

where:

a(W) is the mean of the wait time W;

a(C) is the mean of the total time spent in communications C; and

a(S) is the mean of the total service time S.

Moreover, if the parameters C and S are statistically mutually independent, then the following relationship holds for their variances:

v(W)=v(C)+v(S) (3)

where:

v(W) is the variance of the wait time W;

v(C) is the variance of the total time spent in communications C; and

v(S) is the variance of the total service time S.

Typically, user's perception of the performance of an application is based on the mean and variance of wait times, a(W) and v(W). Therefore, if the a(W) and v(W) can be minimized by balancing the load among a set of servers that provide the same service to clients, then the user perceived performance of an application can be improved.

2. Client-Server System Model

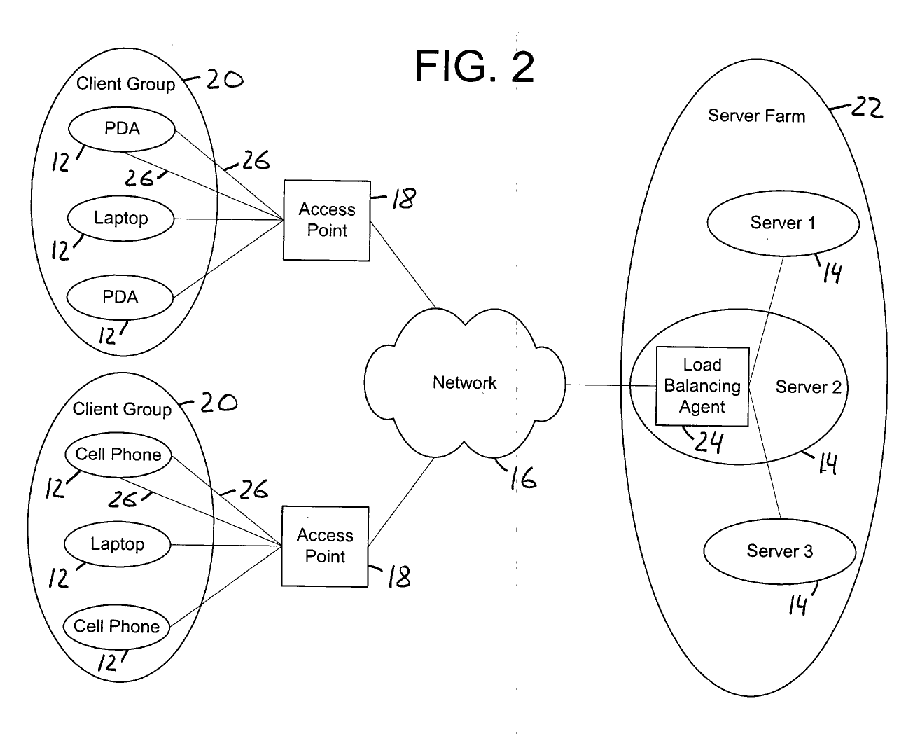

Referring to FIG. 2, there is shown a model client-server system 10 for server load balancing according to an embodiment of the present invention. The client-server system 10 includes two sets of computing devices, client devices 12 and server devices 14, that are interconnected with a network 16, such as a local area network (“LAN”) comprising a single network or a wide area network (“WAN”) comprising a set of interconnected heterogeneous networks. Clients 12 can include various mobile computing devices such as cellular phones, Personal Digital Assistants (“PDAs”), laptop computers and other devices connected to and sharing the network 16 to access internet services. Specifically, a user operating a client device 12 requests services provided by a server application, which can execute on at least one of the servers 14. For example, a user may operate a web browser on a client to request and present data from a database engine that manages data storage and retrieval on a server.

Clients 12 are grouped into one or more client groups 20. In this embodiment, a client group 20 includes all the clients that use the same access point 18 to connect to the network 16. Membership of a client 12 in a client group 20 can be done in a static manner based on the unique ID assigned to each client or it may be done dynamically using the IP addresses of the clients. However, it should be understood that there are a variety of ways of establishing client groups 20. For example, in another embodiment, a client group 20 may include a single client device, or all the clients that access a particular service provider, or all clients within a sector in a WAN that share a common base station.

All communication, including user requests, from a client 12 must pass through an access point 18 before being transmitted over the network 16 to a server 14. A client 12 may have multiple network interfaces corresponding to different access networks 26 for connecting to the access point 18. An access point 18 acts as a communication hub, for example, to allow wireless clients compliant with the 802.11b networking specification to connect to a wired LAN. In addition, an access point 18 can intercept and modify requests from a client 12 within a client group 20 by tagging the requests with unique identifiers, such as a client group id, a user id and an access network id, as described in greater detail further below. Several clients 12 may share an access point 18 and the client-server system 10 may include multiple access points 18.

Referring again to FIG. 2, a group of the servers 14 connected to the network 16 are organized into a server farm 22. Each client 12 in a client group 20 can make a request into the server farm 22 and the request is satisfied by one of the servers 14 in the server farm. The initial members of a server farm 22 are determined by a service provider's system administrator. This can be the fixed set of server machines 14 that the system administrator is willing to maintain in order to provide services sought by clients 12.

In the present embodiment, each server 14 in the server farm 22 is able to handle the same set of requests from a client 12. This implies that applications and data are replicated on each of the server machines 14 in the server farm 22. However, it should be readily understood that it is not necessary to have mirrored data on each server in the server farm 22 since any one of the servers 14 alternatively may obtain the data or application that it needs in order to satisfy a client request from another server in the server farm.

The client-server system 10 also includes at least one load balancing agent 24 that dispatches each client request to an appropriate server 14 dynamically as the request arrives at the server farm 22. Only one load balancing agent 24 executes at any given time. This load balancing agent 24 executes on one of the servers 14 of the server farm 22, known as the load balancing server 14s, although other copies of the load balancing agent can be mirrored on different servers. A system administrator can select which of the servers 14 in the server farm 22 will function as the load balancing server 14s. Any of the servers 14 in the server farm 22 can function as the load balancing server 14s. Alternatively, the load balancing agent 24 can execute on a dedicated device, such as a network switch, placed in front of the server farm 22.

In order to balance the load among the servers 14 of the server farm 22, the load balancing agent 24 intercepts each request from a client 12 into the server farm 22 and selects one of the servers 14 to respond to the client request. In order to intercept client requests, for example, HTTP based applications can export services from servers 14 using a Uniform Resource Locator (“URL”). A pair of values corresponding to a URL and a IP address can be stored at a DNS server through a bind operation. All service URLs for the servers 14 in the server farm 22 are bound to the IP address of the server 14s that executes the load balancing agent 24. When a lookup is done for a particular URL from the DNS server, the IP address is always bound to a load balancing agent 24. This allows the load balancing agent to intercept all requests to the server farm 22.

Once the load balancing agent 24 intercepts a client request, it executes a server load balancing algorithm to select one of the servers 14 for handling the request. The load balancing agent 24 maintains a list of all servers 14 in the server farm 22. If some of the servers 14 are temporarily unavailable or have failed, the load balancing 24 updates its list of active servers that can handle requests from clients. As described in greater detail further below, for each application requested by a client 12 from the server farm 22, the load balancing agent 24 maintains a record of wait times for different servers that have provided the application requested. The load balancing agent then dispatches each client request to one of the servers 14 in the server farm 22 based on the metric of mean and variance of wait times.

2.1 Measuring Wait Times

In order to balance the load on the set of servers 14 in the server farm 22, the load balancing agent 24 needs to know the mean and variance of wait times, communication times and service times for the applications requested by clients 12 from the servers 14. These metrics can be gathered and disseminated in various ways.

For example, a client 12 can measure wait times W for each request to a server 14 using client device libraries that have been modified to intercept all requests that originate from the device. For example, the Java 2 Platform, Micro Edition (J2ME) libraries of a Java based client can be instrumented to intercept all HTTP requests issued by the client. Specifically, the following method can be added to the java.net library of J2ME to collect information on HTML based forms and URL processing:

void recordEvent(EventType et, Event e, TimeStamp t)

Each request and reply pair with a form is recorded and all the events in the form are counted.

Wait times then can be measured using the difference between the timestamps associated with each request/reply pair. For example, a client 12 intercepts all HTTP requests, such as POST and GET methods, to a server 14. When a GET or POST is performed, a first timestamp is taken. When the GET or POST returns and the reply generated by the server is displayed on the browser, a second timestamp is taken. The difference between the first and second timestamps measures the wait time.

The total service time S for responding to a user request can be measured by a server 14 using a timer to measure the difference between the time when the server receives a request, for example, when a “Service( )” method of an application is called in response to a client request, and when a reply is generated. The server 14 can then send the value for the service time S back to the requesting client 12 along with the reply to the client's request. Having obtained the wait time W and the total service time S, the requesting client 12 can calculate the communication time C for the user request as the difference between the wait time W and the total service time S, according to Equation (1) above.

2.2 Collecting and Disseminating Wait Time Measurements

A client 12 can maintain a running average of the mean and variance of the wait time, communication time, and service time, denoted by A(W), A(C), A(S), and V(W), V(C), and V(S), for a requested application. Specifically, the device library of a client 12 will compute and store a running average of the mean and variance of the measured wait times, A(W) and V(W), using values of W measured, as described above, within a given time interval T. Only those wait time values collected over the last T time units are used in the computation of A(W) and V(W). Likewise, a client 12 calculates values for the parameters A(S) and V(S), as well as A(C) and V(C), using measurements of S and C respectively, which are obtained, as described above, within the given time interval T.

Alternatively, a first client 12a may collect information on A(C) from a second client 12b that is using the same access point 18 for communicating with the server farm 22. For example, once the second client 12b computes the parameters W, C and S, it can store the values in a cache memory. This cache of the second client 12b can be synchronized with a cache of the first client 12a, for example, through one of the servers 14 in the server farm 22 that knows which clients share the same access point 18. The systems administrator can designate which of the servers 14a will be is responsible for synchronizing the cache of the second client 12b and first client 12a. All the clients 12 that share the same access point 18 will send their cached information on A(C) to the designated server 14a periodically at a frequency that is set by a system administrator. The server 14a aggregates this data and sends it plus a smoothing interval to the first client 12a when the client requests it. The smoothing interval is a predetermined value indicative of the time between successive load balancing optimizations.

The cache on the second client 12b storing information on A(C) can also be synchronized directly with the first client 12a seeking this information. In this case, each of the clients 12 broadcasts its cached information to other clients through an ad-hoc network such as Bluetooth, IRDA or 802.11b. Such broadcast messages do not have to propagate through the network 16 for communicating between the clients 12 and the servers 14. Instead, the clients 12 individually aggregate data. A smoothing interval may be fixed by the system administrator or the clients 12 can employ a distributed consensus algorithm to come to an agreed upon smoothing interval.

In addition, the wait time metrics of A(W), A(C), V(W) and V(C) can be calculated for each access network 26 available to a client 12 for communicating with a server 14. During think times for an application, a client 12 can collect information on A(C) and V(C) on different access networks 26 available to it using known mechanisms, such as the Internet Control Message Protocol (ICMP). For example, a client can periodically send an ICMP message to a server over an access network. The client can then use an echo reply message from the server to calculate a communication time and keep an average value for this network latency. Values for A(W) and V(W) can be calculated for each available access network by adding A(S) and A(C) and V(S) and V(C) according to the equations shown in Equations (2) and (3). The measured values for these wait time metrics are stored on the client 12 for each access network 26 along with a network ID and are available to be used for making server load balancing decisions, as described in greater detail further below.

A system administrator can also select whether the values for A(W), A(C), A(S), and V(W), V(C), and V(S) are measured by a client 12 on a “per application” or on “a per user per application” basis. A client 12 can be configured for either of these options before it is deployed in the field or dynamically at runtime. If a client 12 measures values for A(W), A(C), A(S), and V(W), V(C), and V(S) per application, the load balancing agent 24 may use this information independent of the user. If these metrics are measured per user per application, the server load balancing algorithm used by the load balancing agent 24 can be tuned to the profiles of different users.

For each set of measured wait time metrics, a requesting client 12 stores process identifiers that designate a starting node and destination node for the client request that formed the basis for the measurements. For example, an identifier for the destination node, which enables a requesting client 12 to identify the particular server that satisfied a client request, may be the IP address or some other unique ID assigned to each server 14 in the server farm 22. In order to publish these identifiers for the servers 14 to the clients 12, the reply generated by a server in response to a client request includes a unique identifier or IP address for that server. The identifier for the starting node may be the unique ID assigned to the client group 20 that includes the requesting client. Also, the starting node identifier may designate an individual user if the requesting client has been configured to measure wait time metrics on a “per user per application” basis. In addition, the starting node identifiers may designate the access network 26 used by the requesting client to communicate with the server farm 22.

In order to make wait time metrics for an application available to the load balancing agent 24 for use by a server load balancing algorithm, a client 12 forwards measured values for A(W), A(C), A(S), and V(W), V(C), and V(S) and corresponding process identifiers to a server 14 along with client requests. Accordingly, a server 14 that receives requests from multiple clients 12 for the same application is able to compute averages and variances of wait times for that application over a large group of clients. In particular, each server 14 can decide how it will treat wait time metrics received from clients 12. The systems administrator can configure a server 14 to aggregate, such as by averaging, values for A(W), A(C), A(S), and V(W), V(C), and V(S) for each individual client, from clients that use the same access point 18 or from clients that are part of the same client group 20. Alternatively, a server 14 can aggregate values received from clients 12 that are within a given distance of each other based on proximity information obtained from the network layer, for example, by using the PHCM protocol.

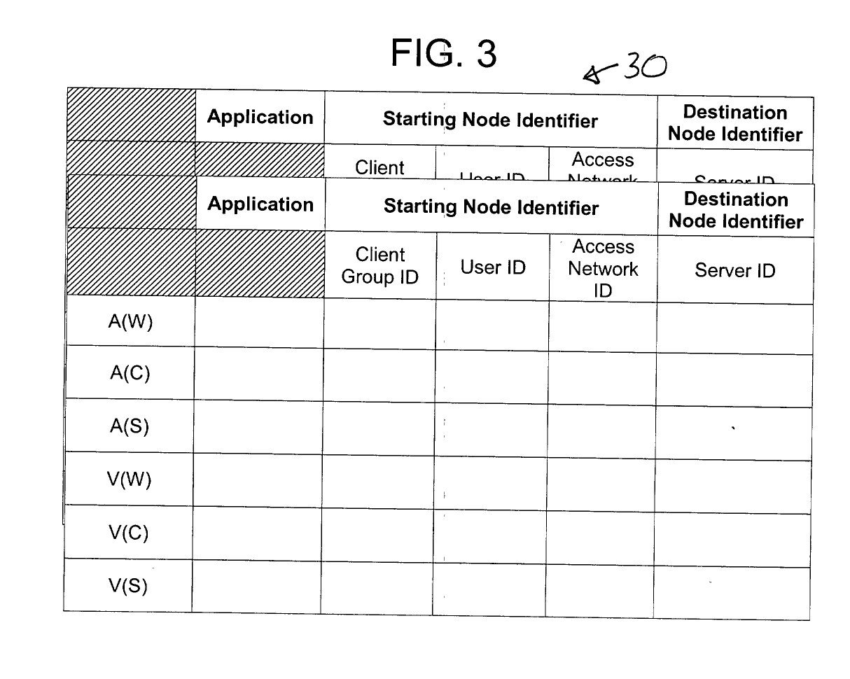

The load balancing agent 24 then collects and stores in a memory of the load balancing server 14s a table 30 of values for the wait time metrics of A(W), A(C), A(S), and V(W), V(C), and V(S) from the different servers 14 in the server farm 22 for each application requested from the server farm, as shown in FIG. 3. For each record 32 of values for the wait time metrics in the table 30, the load balancing agent 24 also stores corresponding process identifiers. This enables the load balancing agent 24 to associate the wait time metrics with individual servers 14 in the server farm 22, client groups 20, users and access networks 26.

Alternatively, each client 12 can periodically send A(W), A(C), A(S), and V(W), V(C), and V(S) information directly to the load balancing agent 24, which can then aggregate this information for a given application based on a client grouping policy specified by the system administrator, as described above.

3. Server Load Balancing Process

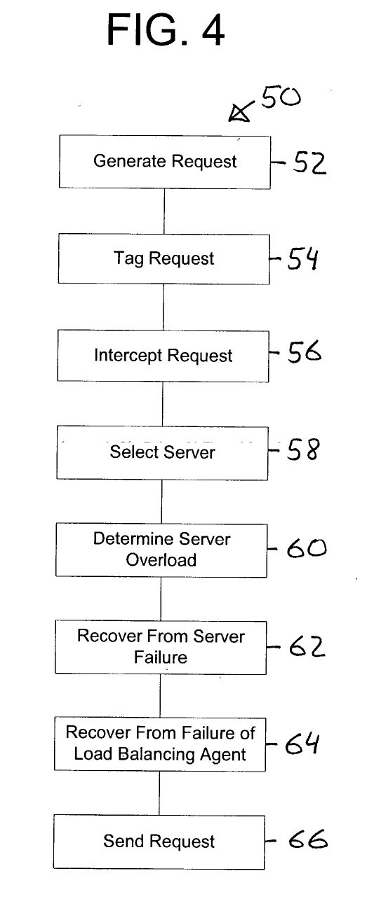

FIG. 4 is a flow chart showing a server load balancing process 50 according to an embodiment of the present invention.

Step 52: Generate Request

In step 52, a client forming part of a client group generates a request in a HTTP protocol transaction to a server in a server farm. A HTTP transaction typically involves establishing a connection between a client and a server, sending a request message from the client to the server, sending a response back to the client from the server, and closing the connection. A HTTP request typically includes a request line, a header and a body. The request line identifies the HTTP command used, such as a POST and GET method, the resource that the client is requesting from the server, if any, and the HTTP version number. The request header consists of one or more lines, each of which may contain configuration information about the client, server, or data being sent. The request body will contain any data that is being sent to the server if the POST method was used in the HTTP request line.

Step 54: Tag Request

The client request of step 52 then passes through an access point, which tags the HTTP request header with a field that uniquely identifies the client group from which the request originated in step 54 and the destination server. The system administrator may specify that the access point must also tag the request header to identify the particular user sending the request and the access network used to transmit the request.

Step 56: Intercept Request

Next, in step 56, the tagged client request is intercepted by a load balancing agent before the request is processed by a server in the server farm. As described above, all HTTP client requests are bound to the IP address of the load balancing agent using a DNS server. The load balancing agent determines the application being requested from the HTTP request line as well as the client group from which the client request originated. The load balancing agent may also identify the user making the request and the access network used by the client to transmit the request from the information included in the HTTP request header in step 54.

Step 58: Select Server

Then, in step 58, the load balancing agent selects a server in the server farm to respond to the intercepted request. The load balancing agent can implement various algorithms for server load balancing based on the mean and variance of the wait time, communication time, and service time for the requested application. A flowchart of an exemplary algorithm for selecting a server is shown in FIG. 4. Generally, the exemplary algorithm of FIG. 4 attempts to select the server having the minimum mean wait time for servicing requests from a particular client group; unless there is more than one server with the same minimum mean wait time, in which case it may select the server with the minimal variance of wait times.

Specifically, for each application that a client may request from a server in the server farm, the system administrator sets a maximum threshold A_T for the mean wait time. Additionally, there is a maximum variance of wait times for each application that is set by the system's administrator to V_T. As described above, the load balancing agent can also index into a table of measured values of A(W), A(C), A(S), and V(W), V(C), and V(S) for individual servers in the server farm.

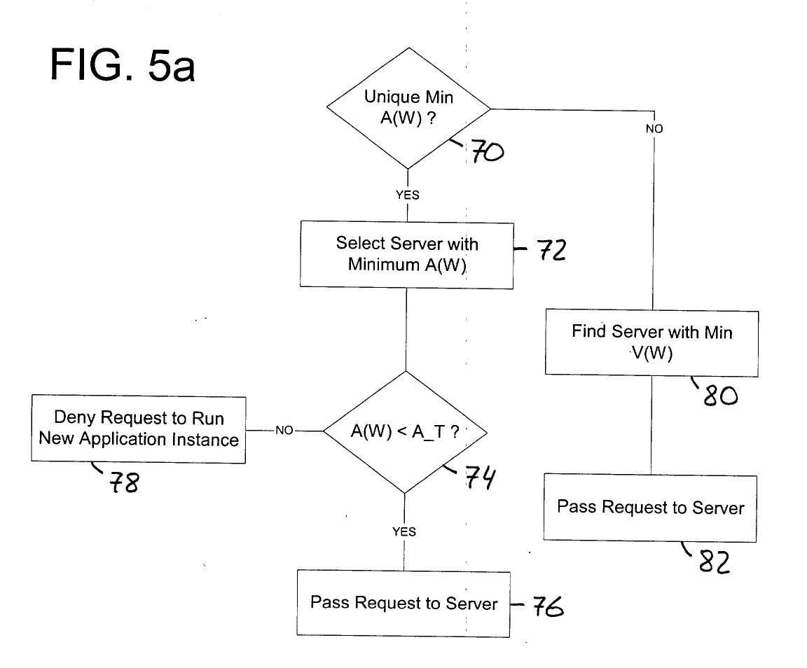

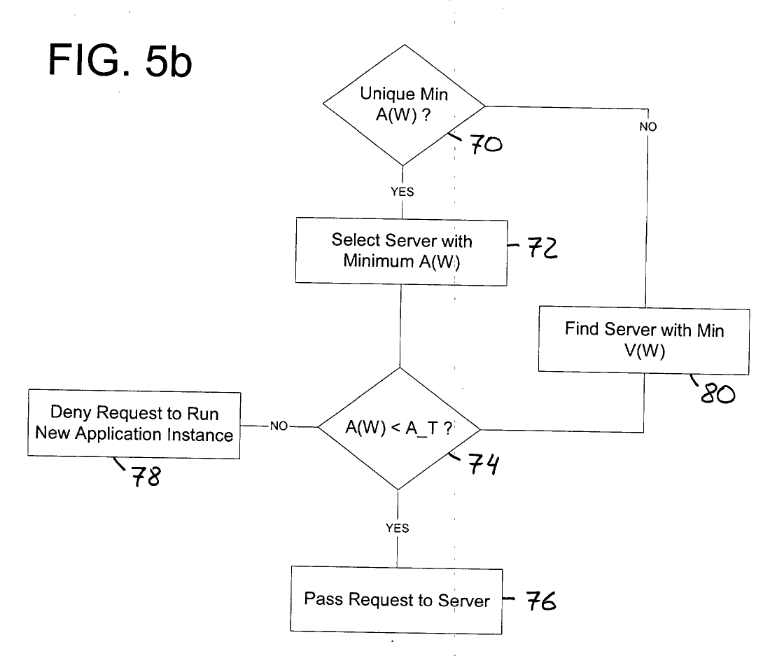

Referring to FIG. 5a, the load balancing agent first determines the lowest recorded value of A(W) for the application requested among all of the servers in the server farm in step 70. The load balancing agent will search its table of measured values of wait time metrics for those measurements of A(W) corresponding the client group identified in step 54. If the HTTP request header additionally specifies a user identity, the load balancing agent will further consider only those measurements of A(W) corresponding to requests issued by that particular user. Likewise, the load balancing agent may use only those measurements of A(W) corresponding to the access network specified in the request header, if any. This allows the load balancing agent 24 to tailor algorithms for load balancing the server traffic to meets the needs of individual users and optimize user perceived performance based on the client group and access network in use.

If there is a unique minimum value for A(W) among all of the servers in the server farm that meets the criteria discussed above, then the load balancing agent identifies the IP address of the server corresponding to this value for A(W) in step 72.

Next, the load balancing agent determines whether the minimum value for A(W) is less than the threshold value of A_T for the requested application in step 74. If so, in step 76, the load balancing agent transmits the client request to the server identified in step 72. Otherwise, the load balancing agent will block requests to run further instances of the application in step 78 if the minimum value for A(W) is greater than the threshold A_T of the application. Subsequently, when the wait time condition changes and the minimum mean wait time falls below the threshold A_T, the requests for the application can resume.

On the other hand, if there are several servers having the same minimum value for A(W), the load balancing agent will find the server having the lowest variance of wait times V(W) in step 80. Again, the load balancing agent will consider only a select group of measurements for V(W) corresponding to the criteria discussed above in step 70, such as measurements corresponding to the client group identified in step 56. In case there is more than one server with the same minimum value for V(W), the load balancing agent can arbitrarily select one of these servers. Once the server is selected based on the minimum value for V(W), the load balancing agent will pass the client request to that server in step 82. Alternatively, the load balancing agent can verify that A(W) is greater than A_T before passing a request to the server having the lowest variance of wait times V(W), as shown in step 84 in FIG. 5b.

However, it should be understood that the algorithms of FIGS. 5a and 5b are meant to be illustrative rather than limiting. Other algorithms may be used for selecting a server based the measured wait times metrics. For example, an algorithm may use the measured variance of wait times V(W) to initially filter out servers and then select the server with the minimum variance to respond to a client request.

Referring again to the exemplary algorithm of FIG. 4, once the load balancing agent selects a server to respond to the client request in step 58, it can cache the identity of the selected server so that future requests by that client for the same application are automatically sent to the previously selected server. This cached identity of the selected server is invalidated after a given period of time, and must then be recomputed.

The load balancing agent can also store a list of the IP addresses of all servers in the server farm. Once the server load balancing algorithm selects a server to service a client request, the load balancing agent can return the IP address of the selected server to the requesting client. The requesting client then can address subsequent messages directly to the selected server. This enables the load balancing agent to execute in a pass-through mode, in which client requests are merely passed to the server specified by the client, thereby avoiding the overhead associated with executing the load balancing algorithm for redirecting client requests.

Also, a client may want to establish a session for a service offered by a server. For purposes of this application, a session is defined as a set of integral HTTP requests. Any session protocol may be used, such as the Session Initiation Protocol (“SIP”). For each session that is established, once the load balancing agent selects a server to respond to an initial request in a session, a client can bind to that server for the duration of the session. This enables the client to direct the load balancing agent to operate in a pass-through mode and route all requests to the same server for the limited duration of a session.

However, the load balancing agent may choose to rerun the server load balancing algorithm of FIG. 5a and a different server may be rebound to service client requests whenever a predetermined condition is met, for example, if the measured wait times fluctuate by a given amount Delta_A(W) from a benchmark value of A(W).

Step 60: Determine Server Overload

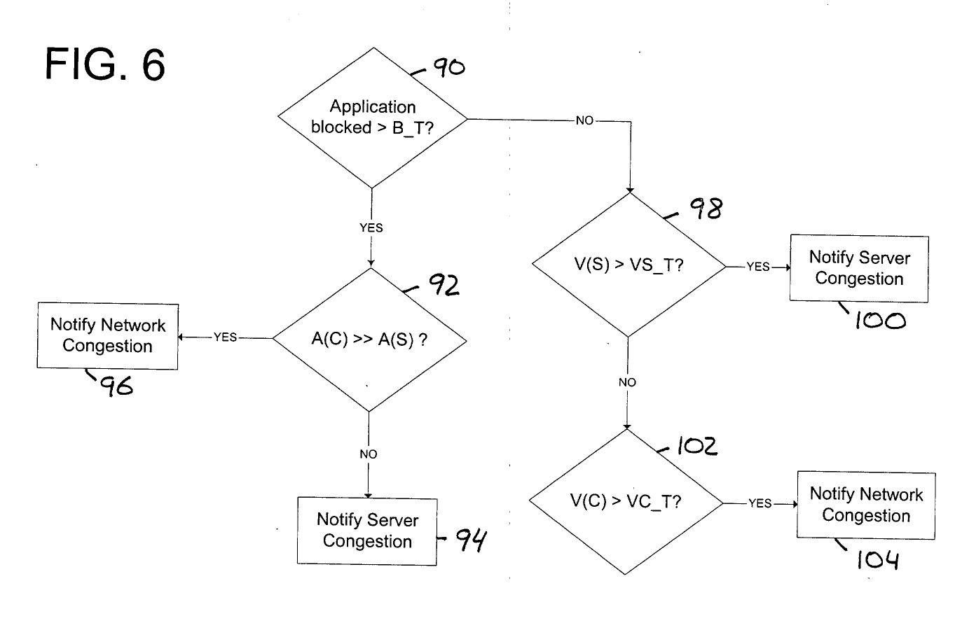

In addition to selecting an appropriate server to respond to the client request, the load balancing agent also detects whether the client-server system is overloaded and fails to provide satisfactory performance in step 60. A flowchart for an exemplary algorithm for diagnosing a system overload is shown in FIG. 6. Specifically, in step 90, the load balancing agent determines whether the number of blocked requests for a new application instance, such as HTTP request using the GET or POST method to initiate a new connection to a server, is greater than a given threshold value B_T, which is set by the system administrator. As described above, a request may be blocked if the mean wait time A(W) increases above a given threshold A_T. If the number of application requests denied is greater than B_T, then the load balancing agent determines whether the wait time delays are caused by server or network congestion in step 92. If the mean communication time A(C) is much greater than the mean service time A(S) in step 92, for example twice as great, the load balancing agent will notify the system administrator of network congestion in step 96. Otherwise, it will notify the system administrator of server congestion in step 94.

In addition, even if the number of application requests denied is not greater than B_T in step 90, the load balancing agent will still attempt to determine if there is network or server congestion. In particular, the load balancing agent will determine whether the variance of the service time has increased above a given threshold VS_T in step 98. If so, it will notify the system administrator that the server is congested in step 100. In addition, the load balancing agent will determine whether the variance of the communication time has increased above a given threshold VC_T in step 102. If so, it will notify the system administrator that the network is congested in step 104.

This analysis can be done in real time and reported to the system administrator in real time through email. The technique allows the system administrator to take appropriate actions when the wait times for requests may unfavorable impact user experience.

Step 62: Recover from Failure of Individual Server

Furthermore, the load balancing agent will detect and recover from the failure of a server that has been previously selected to service the client request in step 62. In order to do so, the load balancing agent maintains a list of available servers in the server farm. The system administrator can supply a list of all the IP and MAC addresses of all the servers in the server farm. The load balancing agent also pings each server periodically. The period is set by the system's administrator. When a new server is added to the server farm, it must wait for the next ping period of the load balancing agent to join the server farm. If a server ceases to respond or otherwise leaves the server farm during request processing, the load balancing agent will time out in its communication with that server.

If the load balancing agent times out while trying to distribute a client request to a server, the request can be sent to another server in the server farm to service the request. This new server can be selected according to the method of step 58, except that the mean wait time A(W) of the timed out or crashed server is not considered by the server selection algorithm of FIG. 4.

Step 64: Recover from Failure of Load Balancing Agent

In step 64, if the current load balancing agent has failed, an alternate load balancing agent is provided to replace it. Replacement occurs by selecting a mirrored copy of the load balancing agent from one of the remaining servers in the server farm.

In particular, a group membership protocol, such as ISIS Group Management Protocol, can be used to maintain the group of servers forming the server farm. For example, those skilled in the art will recognize that a consensus algorithm can determine group membership. Also, heartbeat algorithms that use timestamps to identify timeouts can detect when a member leaves the group. In the event that a member or server leaves the group or server farm due to a failure, the group of servers reforms. In addition, a leader election algorithm can select a leader for the group of servers forming the server farm to coordinate the group's activities with outside entities. An exemplary technique for selecting a group leader is to select the group member or server having the smallest IP address.

The server elected as the group leader then is responsible for executing the load balancing agent. If this server fails or the load balancing agent ceases to respond, then a new group leader can be elected by the group. The newly elected group leader assumes the responsibility of executing a mirrored copy of the load balancing agent. The IP address of the new group leader executing the load balancing agent is passed to the DNS server to allow the load balancing agent to intercept client requests.

Step 66: Send Request to Server

In step 66, the load balancing agent dispatches the client request to the server selected in step 58. In order to prevent thrashing resulting from too many requests to the same server machine, a smoothing technique can be employed that allows a given number of requests N to be sent to a server machine per time period TT. The parameters N and TT can be by the systems administrator of the network depending upon the hardware attributes of the devices in the client-server system.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A method for load balancing a plurality of servers comprising:
intercepting a request from a requestor client forming part of a client group for a service provided by the plurality of servers;
determining wait times for servicing prior requests from at least one member client of the client group by at least one of the plurality of servers; and
selecting an execution server from among the plurality of servers for responding to the request dynamically based on a computation of the wait times.

2. The method of claim 1, wherein said request is intercepted and said execution server is selected by a load balancing agent executing on one of said plurality of servers.

3. The method of claim 1 further comprising:
tagging said request with a client group identifier at an access point shared by said client group;
wherein said wait times are determined based on said client group identifier.

4. The method of claim 3 further comprising:
tagging said request with a user identifier at said access point;
wherein said wait times are determined based on said user identifier.

5. The method of claim 3 further comprising:
tagging said request with an access network identifier at said access point;
wherein said wait times are determined based on said access network identifier.

6. The method of claim 1, wherein said computation comprises at least one of a mean of said wait times and a variance of said wait times.

7. The method of claim 6 wherein said execution server has the lowest mean of said wait times from among said plurality of servers.

8. The method of claim 6 wherein said execution server has the lowest variance of said wait times from among said plurality of servers.

9. The method of claim 1, wherein said wait times include communication times and service times, further comprising:
determining an overload of said execution server using a mean and a variance of said communication times and said service times.

10. The method of claim 1 further comprising recovering from a failure of said execution server by re-selecting a new execution server based on said computation of the wait times.

11. The method of claim 2 further comprising recovering from a failure of said load balancing agent using a group membership protocol.

12. A system for load balancing a plurality of servers comprising:
a client group including at least one client operable to generate a request for a service provided by the plurality of servers;
a memory for storing record of wait times for servicing prior requests from said client group by at least one of the plurality of servers; and
a load balancing agent executing on one of the plurality of servers capable of intercepting the request and selecting an execution server from among the plurality of servers for responding to the request dynamically based on a computation of the wait times.

13. The system of claim 12 further comprising an access point connected with said client group and a network, said network interconnecting said plurality of servers and said access point, said access point operable to tag said request with a client group identifier.

14. The system of claim 13, wherein said access point is further operable to tag said request with at least one of a user identifier and an access network identifier.

15. The system of claim 12, wherein said computation comprises at least one of a mean of said wait times and a variance of said wait times.

16. The system of claim 15 wherein said execution server has the lowest mean of said wait times from among said plurality of servers.

17. The system of claim 15 wherein said execution server has the lowest variance of said wait times from among said plurality of servers.

18. The system of claim 12, wherein said wait times include communication times and service times, and said load balancing agent is further operable to determine an overload of said execution server using a mean and a variance of said communication times and said service times.

19. The system of claim 12 wherein said load balancing agent is further operable to recover from a failure of said execution server by re-selecting a new execution server based on said computation of the wait times.

20. The system of claim 12 further comprising a group membership protocol for recovering from a failure of said load balancing agent.

21. The system of claim 12, wherein said memory is located on said one of the plurality of servers capable of intercepting the request and selecting an execution server from among the plurality of servers for responding to the request dynamically based on a computation of the wait times.
